(19) United States
(12) Patent Application Publication
(10) Pub. No.: US 2026/0202355 A1
(43) Pub. Date: Jul. 16, 2026

(54) X-RAY IMAGING SYSTEM AND METHOD FOR OPERATING AN X-RAY IMAGING SYSTEM

(71) Applicant: Carl Zeiss SMT GmbH, Oberkochen (DE)

(72) Inventor: Joy ROY, Danville, CA (US)

(21) Appl. No.: 19/015,782

(22) Filed: Jan. 10, 2025

(51) Int. Cl. G01N 23/04; G01N 23/083

(52) U.S. Cl. CPC G01N 23/04; G01N 23/083; G01N 2223/204; G01N 2223/6116

(57) ABSTRACT

An x-ray imaging system for imaging a sample, comprising: a sample mount for supporting the sample; an x-ray source for emitting x-rays toward a region of interest of the sample; and an x-ray detector for detecting x-rays transmitted through the region of interest, wherein the sample mount comprises an opening for passing through of the emitted x-rays and/or the transmitted x-rays.

### INCORPORATION BY REFERENCE

This application incorporates by reference the following commonly owned applications filed on even date herewith:
USSN ______ (Attorney Docket: 36066-0080001), entitled “X-Ray Source for an X-Ray Imaging System and X-Ray Imaging System”;
USSN ______ (Attorney Docket: 36066-0082001), entitled “Sample Mount Assembly for An X-Ray Imaging System and X-Ray Imaging System”;
USSN ______ (Attorney Docket: 36066-0083001), entitled “X-Ray Source for an X-Ray Imaging System, X-Ray Imaging System and Method for Operating an X-Ray Imaging System”;
USSN ______ (Attorney Docket: 36066-0084001), entitled “X-Ray Detector Assembly, X-Ray Imaging System and Method for Manufacturing an X-Ray Detector Assembly”; and
USSN ______ (Attorney Docket: 36066-0085001), entitled “X-Ray Imaging System”.

### FIELD

The present disclosure relates to an x-ray imaging system and a method for operating such an x-ray imaging system.

### BACKGROUND

X-rays are widely used in microscopy in part because of their short wavelengths and ability to penetrate objects. Three-dimensional (3D) x-ray imaging techniques are useful to image internal structures of objects. Typically, based on a dataset including x-ray transmission images of a sample that are collected over a large angular range, 3D images are reconstructed. An x-ray imaging system usually comprises a sample mount to support a sample, an x-ray source configured to illuminate a region of interest of the sample, and a position-sensitive x-ray detector configured to record x-rays transmitted through the region of interest of the sample.

The x-ray flux incident on the region of interest of the sample is, in general, inversely proportional to the square of the distance of the region of interest from the x-ray source. Decreasing this distance can increate throughput for x-ray imaging. In other words, it would be desirable to place the region of interest of the sample as close to the x-ray source as reasonably possible such that the x-ray flux density at the region of interest is as high as reasonably possible. A high x-ray flux density at the region of interest of the sample generally implies relatively short exposures times and, hence, a relatively high throughput of a series of samples imaged with the x-ray imaging system.

### SUMMARY

It is one object of the present disclosure to provide an improved x-ray imaging system and an improved method for operating an x-ray imaging system.

According to a first aspect, the disclosure provides an x-ray imaging system for imaging a sample is provided. The x-ray imaging system comprises: a sample mount for supporting the sample; an x-ray source for emitting x-rays towards a region of interest of the sample; and an x-ray detector for detecting x-rays transmitted through the region of interest, wherein the sample mount comprises an opening for passing through of the emitted x-rays and/or the transmitted x-rays.

Having the sample mount with the opening allows to prevent that the x-ray beam traveling from the x-ray source to the region of interest of the sample and to the x-ray detector transmits the sample mount. Hence, a distortion (e.g., attenuation) of the x-ray beam by material of the sample mount can be avoided. Thus, an x-ray imaging of the region of interest of the sample can be improved. For example, an accuracy and/or signal-to-noise ratio of the x-ray imaging can be increased.

The x-ray imaging system is configured for imaging a region of interest of a sample. The sample is, for example, a flat extended object. The sample is, for example, a wafer. The wafer includes, for example, electronic and/or semiconductor components. Just as an example, the x-ray imaging system may be used to inspect the wafer to investigate the quality of packaging of electronic components of the wafer. For example, the quality of mechanical and electrical bonding (e.g., buried interconnections) of the electronic components may be controlled. However, the sample may also be another object than a wafer. The sample is, for example, a circuit board or a battery.

The x-ray imaging system is, for example, a transmission x-ray imaging system, wherein the x-rays impacting on the region of interest of the sample are partly transmitting the region of interest and are partly absorbed by the region of interest. The position-dependent transmitted portion of the x-rays can be detected by the detector (e.g., a position-sensitive x-ray detector) as a two-dimensional x-ray image.

The x-ray imaging system is, for example, a three-dimensional imaging system. The x-ray imaging system is, for example, configured to obtain two-dimensional transmission images of the region of interest for different rotation angles of the sample. Based on the two-dimensional transmission images, a three-dimensional image of the region of interest can be reconstructed to reveal interior structures of the region of interest. The x-ray imaging system comprises, for example, a control device for reconstructing the three-dimensional images. The x-ray imaging system is, for example, an x-ray three-dimensional imaging system obtaining three-dimensional images by x-ray laminography and/or x-ray tomography.

The sample mount has, for example, a support surface for supporting the sample. The support surface is, for example, defining an object plane of the x-ray imaging system.

The sample mount and/or a sample mount assembly including the sample mount is, for example, configured for supporting the sample rotatably around a rotation axis. The sample mount assembly comprises, for example, a rotation drive for rotating the sample mount. For example, the x-ray imaging system is configured for obtaining two-dimensional transmission images of the region of interest of the sample for different rotation angles of the sample with respect to the rotation axis, wherein the rotation angles span a large angular range of, for example, 180° or larger (e.g., 270° or larger, 360°). Furthermore, the x-ray imaging system is, for example, configured for reconstructing a three-dimensional image of the region of interest based on the two-dimensional transmission images.

The sample mount comprises the opening for letting the x-rays emitted by the x-ray source and/or the x-rays transmitted through the region of interest of the sample pass through. The opening is, for example, a through opening, a passage opening, and/or a passageway opening.

The opening of the sample mount may also be configured for at least partially accommodating a protruding portion of the x-ray source.

The opening is, for example, a circular opening. However, the opening may also have another geometric shape (e.g., oval, rectangular, squared, polygonal, hexagonal etc.).

Furthermore, a size (e.g., a diameter) of the opening has, for example, a value in the range of 3 centimeters (cm) or more (e.g., 4 cm or more, 5 cm or more, 10 cm or more, 15 cm or more).

The opening of the sample mount may have, for example, a thin cover with a pin hole of (e.g., approximately) a size (e.g., slightly) larger (e.g., by 1% or more, 2% or more, 5% or more) than the desired size of the x-ray beam (e.g., approximately 1 millimeter (mm)) that is directed towards the region of interest of the sample. In some embodiments, the opening of the sample mount has a cover with a pin hole the size or diameter of or up to 1% (e.g., up to 2%, up to 5%) larger than the size or diameter of an x-ray beam that is directed towards the region of interest of the sample.

The x-ray source comprises, for example, a vacuum chamber. Further, the x-ray source comprises, for example, a pump for evacuating the vacuum chamber.

The x-ray source further comprises, for example, an electron source accommodated in the vacuum chamber. The electron source is configured for emitting an electron beam towards an x-ray target of the x-ray source. The electron source includes, for example, a cathode and an anode and the like for generating electrons and for accelerating the generated electrons.

The x-ray source comprises, for example, one or more electron optics units for directing, deflecting and/or shaping the electron beam emitted from the electron source. The electron optics include, for example, one or more magnetic lenses for focusing the electron beam and/or one or more deflection units for deflecting the electron beam. The one or more electron optics units further include, for example, a collimator such as a magnetic focus lens for focusing the electron beam before the electron beam hits the x-ray target.

The x-ray source further comprises, for example, an x-ray target. The x-ray target is configured for emitting x-rays when bombarded with the focused electron beam. A material of the at least one x-ray target comprises, for example, one or more of a group including tungsten, copper, and chromium. The x-rays generated by the at least one x-ray target can include characteristic lines determined by the target's composition and broad bremsstrahlung radiation.

The x-ray source includes, for example, a carrier element carrying the x-ray target (or carrying multiple of the x-ray targets which can be selected by directing the electron beam accordingly). The carrier element is, for example, x-ray transmissive. The carrier element forms, for example, a vacuum window of the vacuum chamber. Alternatively, an additional vacuum window may be provided. A material of the carrier element and/or the vacuum window includes, for example, atomic elements having atomic numbers less than 14. The material of the carrier element and/or the vacuum window includes, for example, one or more of a group including beryllium, diamond, boron carbide, silicon carbide, aluminum, and beryllium oxide. The material of the carrier element and/or the vacuum window can be diamond.

The carrier element and/or the vacuum window being x-ray transmissive means, for example, that it has an x-ray transmission such that more than 50% of the x-rays generated by the at least one x-ray target having energies greater than one-half of the selected maximum focused electron energy are transmitted through the carrier element.

The carrier element has, for example, a sufficiently high thermal conductivity to provide a thermal conduit to prevent thermal damage (e.g., melting) of the x-ray target. Further, the carrier element can, for example, also provide an electrically conductive path to dissipate electric charge from the at least one x-ray target and/or the carrier element itself.

The x-ray source is, for example, a transmission target type x-ray source. The electron beam can strike the at least one x-ray target of the x-ray source at its backside and the at least one x-ray target emits x-rays at its front side, the emitted x-rays are used to irradiate the sample.

The x-ray source can generate diverging x-rays, i.e. a cone (conus) of x-rays. A portion (i.e. a sub cone) of the generated diverging x-rays can irradiate the region of interest of the sample. A center line of this sub cone of x-rays is referred herein as x-ray propagation axis. This means that the x-ray propagation axis indicates the direction of an x-ray beam which is a portion of the total generated diverging x-rays of the x-ray source.

According to some embodiments, a beam path of an x-ray beam emitted from the x-ray source, transmitted through the region of interest and detected by the detector is free of the sample mount.

The beam path is, for example, free of material of the sample mount. Therefore, the x-rays reaching the detector have not been transmitted the material of the sample mount.

A center line of this beam path is, for example, given by the x-ray propagation axis.

In some embodiments, the beam path of the x-ray beam emitted from the x-ray source, transmitted through the region of interest and detected by the detector is free of any component apart from the sample and/or apart from the region of interest of the sample.

The x-ray beam emitted from the x-ray source, transmitted through the region of interest and detected by the detector is, for example, the usable x-ray beam. The x-ray beam emitted from the x-ray source, transmitted through the region of interest and detected by the detector is, for example, that portion of the x-ray cone which is detectable by the x-ray detector. For example, the x-ray beam emitted from the x-ray source, transmitted through the region of interest and detected by the detector is defined by dimensions of the x-ray detector (e.g., dimensions of a (e.g., two-dimensional) detector array of the x-ray detector).

According to some embodiments, the x-ray imaging system is configured such that an x-ray beam emitted from the x-ray source passes through the opening of the sample mount before irradiating the region of interest of the sample.

For example, the sample mount comprises a support side (or front side) for supporting the sample and a backside arranged opposite the support side. Further, in this embodiment, the x-ray source can be arranged at least partly at the backside of the sample mount. In addition, the x-ray detector can be arranged at the front side of the sample mount.

However, in other embodiments, the x-ray imaging system may be configured such that an x-ray beam already transmitted through the region of interest of the sample passes through the opening of the sample mount before reaching the x-ray detector. In this configuration, the x-ray source can be arranged at least partly at the front side of the sample mount, and the x-ray detector can be arranged at the backside of the sample mount.

According to a further embodiment, the x-ray source comprises a protruding portion protruding from a remaining portion of the x-ray source, the protruding portion including an x-ray target, and the protruding portion of the x-ray source being configured for at least partial insertion into the opening of the sample mount.

That the protruding portion of the x-ray source is configured for at least partial insertion into the opening of the sample mount includes that a cross section of the protruding portion is smaller than a cross section of the opening.

The cross-section size (e.g., diameter) of the protruding portion of the x-ray source is, for example, by 2 cm or more (by 3 cm or more, by 4 cm or more) smaller than the cross-section size (e.g., diameter) of the opening.

The cross-section size (e.g., diameter) of the protruding portion of the x-ray source is, for example, 0.5 cm or more (e.g., 1 cm or more, 2 cm or more, 5 cm or more, 10 cm or more, 12 cm or more).

Having the protruding portion with the x-ray target protruding from the remaining portion of the x-ray source and inserting it at least partially into the opening of the sample mount can allow for arranging the x-ray target of the x-ray source relatively close to the region of interest of the sample. Since the x-ray flux incident on the region of interest is, in general, inversely proportional to the square of the distance of the region of interest from the x-ray target, with the proposed configuration a relatively high x-ray flux density at the region of interest of the sample can be achieved. A high x-ray flux density at the region of interest generally implies short exposures times and, therefore, a series of samples can be analyzed relatively quickly with the x-ray imaging system resulting in a relatively high throughput rate.

For example, the x-ray source can be arranged at a distance to the region of interest of the sample of 1.0 mm or less (e.g., 0.8 mm or less, 0.6 mm or less, 0.5 mm or less, 0.4 mm or less, 0.3 mm or less, 0.2 mm or less, 0.1 mm or less, 0.05 mm or less).

The source has, for example, an x-ray target emission plane that can be arranged at a distance to the region of interest of the sample of 1.0 mm or less (e.g., 0.8 mm or less, 0.6 mm or less, 0.5 mm or less, 0.4 mm or less, 0.3 mm or less, 0.2 mm or less, 0.1 mm or less, 0.05 mm or less).

For example, in comparison with a sample mount without the opening, a distance between the x-ray target and the sample is at least the thickness of the sample mount (e.g., 2.5 mm). However, having the opening and the proposed x-ray source with the protruding portion with the x-ray target, the x-ray target can, for example, be arranged at a distance to the sample of 0.3 mm. Given that the x-ray flux incident on the region of interest of the sample is inversely proportional to the square of the distance of the region of interest from the x-ray source, the difference in x-ray power at the region of interest is a factor of about 70, since (2.5/0.3)² is equal to 69. In other words, by moving the x-ray target from a distance of 2.5 mm to a distance of 0.3 mm towards the region of interest of the sample, a gain in x-ray power of about 70 is achieved.

A thickness of the sample mount has, for example, a value in the range of 1.5 mm to 4.0 mm (e.g., 2.0 mm, 2.5 mm).

According to some embodiments, the sample mount is provided rotatably around a rotation axis of the sample mount, and the rotation axis passes through the opening of the sample mount.

Thus, by rotating the sample mount around the rotation axis, the sample can be rotated suitably for obtaining x-ray images (e.g., two-dimensional transmission images) of the region of interest of the sample at different rotation angles with respect to the rotation axis.

The sample is, for example, arranged on the sample mount such that the region of interest of the sample is arranged at the opening of the sample mount. Further, the sample is, for example, arranged on the sample mount such that the rotation axis of the sample mount passes through the region of interest of the sample.

A sample mount assembly of the x-ray imaging system comprises, for example, a sample mount basis, wherein the sample mount is attached to the sample mount basis rotatably around the rotation axis.

According to some embodiments, the rotation axis of the sample mount coincides with a central axis of the opening of the sample mount.

According to some embodiments, the x-ray imaging system comprises a relocation unit for relocating the sample relative to the sample mount, and for arranging the sample on the sample mount such that the region of interest of the sample is arranged at the opening of the sample mount.

Having the relocation unit, the sample can be easily arranged on the sample mount. Further, having the relocation unit, the sample can be arranged on the sample mount with its region of interest placed on the opening.

Furthermore, for a sample having multiple regions of interest located at different positions of the sample, the sample can be positioned by the relocation unit subsequently for each region of interest such that the respective region of interest is arranged at the opening of the sample mount. Moreover, also regions of interests of different samples can be easily placed by the relocation unit at the opening of the sample mount.

Moreover, having the separate relocation unit for relocating the sample with respect to the sample mount, the sample mount itself does not need to be relocatable apart from a rotation around its rotation axis. This can help allow an easier configuration, manufacture and maintenance of the sample mount. The relocation unit is, for example, independent from the sample mount.

The relocation unit includes, for example, a robotic unit. The relocation unit allows, for example, an automatic relocation of the sample with respect to the sample mount. An automatic relocation means, in particular, that the relocation of the sample is performed without any manual interaction of a user and/or that the relocation of the sample is performed entirely computer controlled.

The relocation unit comprises, for example, one or more tools and/or end effectors for taking up (e.g., lifting up) the sample. The relocation unit comprises, for example, two or more forks for taking up the sample. The relocation unit includes, for example, a forklift. However, the relocation unit may also have another configuration suitable for moving the sample in a translational manner and/or rotational manner.

That the region of interest of the sample is arranged at the opening of the sample mount, includes, for example, that the region of interest is not covered by the sample mount. In other words, the (e.g., entire) region of interest is exhibited at the sample mount through the opening. The region of interest is, for example, exhibited at the sample mount as seen from a backside of the sample mount. Herein, a support side of the sample mount supporting the sample is called a frontside of the sample mount and the backside of sample mount is arranged opposite the support side.

According to some embodiments: the relocation unit is configured for translating and/or rotating the sample relative to the sample mount; the relocation unit is configured for rotating the sample relative to the sample mount around a further rotation axis arranged parallel to the rotation axis of the sample mount; and/or the further rotation axis coincides with a central axis of the sample.

The relocation unit is, for example, configured for translating the sample relative to the sample mount in three translational degrees of freedom (x, y, z), the three translational degrees of freedom spanning up a three-dimensional space (e.g., three directions in space which are arranged perpendicular to each other).

The relocation unit is, for example, configured for rotating the sample relative to the sample mount in at least one rotational degree of freedom, e.g., a rotation (Rz) around a direction arranged parallel to the rotation axis of the sample mount. The relocation unit may also be configured for rotating the sample relative to the sample mount in three rotational degrees of freedom (Rx, Ry, Rz) corresponding to a rotation around the three directions of the translational degrees of freedom (x, y, z).

According to some embodiments, the sample mount comprises a support surface for supporting the sample such that an outer portion of the sample is protruding from the support surface.

Thus, the outer protruding portion of the sample—which is not laying on the support surface—can be mechanically contacted (e.g., taken up and/or lifted) by the relocation unit (e.g., by tools and/or end effectors of the relocation unit) to relocate the sample.

The outer portion of the sample is a portion of the sample remote from a central axis of sample.

According to some embodiments, the sample mount comprises a support side including a support surface for supporting the sample, the support side comprising at least one recess recessed from the support surface, and the relocation unit comprising at least one tool for inserting the at least one tools into the at least one recesses of the sample mount.

The relocation unit and the at least one tool of the relocation unit are, for example, independent from the sample mount.

Having the at least one recess of the sample mount means that the relocation unit can more easily take up and move the sample.

The at least one recess includes, for example, two or more recesses. Further, the at least one tool includes, for example, two or more forks for inserting the two or more forks into the two or more recesses. In this case, the relocation unit may, for example, be configured as a forklift.

The at least one recess includes, for example, a c-shaped recess. Further, the at least one tool includes, for example, a c-shaped arm for inserting the c-shaped arm into the c-shaped recess.

According to some embodiments, the x-ray imaging system comprises a sensor unit for detecting a distance between the x-ray source and the sample.

The sensor unit is, for example, configured for detecting a distance between a protruding portion of the x-ray source and the sample. For example, the x-ray source comprises the sensor unit, e.g., the sensor unit is attached to the x-ray source.

The sensor unit comprises, for example, one or more distance sensors, one or more capacitive sensors, one or more inductive sensors, one or more optical sensors, one or more interferometers, and/or one or more cameras.

Thus, when arranging the x-ray source very close to the sample, a distance between the x-ray source and the sample can be monitored. For example, the distance between the x-ray source and the sample can be controlled to be at a predetermined desired distance. The predetermined desired distance may be a distance which can help ensure a desired x-ray flux density at the region of interest of the sample. Further, the predetermined desired distance may be a predetermined minimum distance which ensures that a physical contact between the x-ray source and the sample is prevented.

According to some embodiments, the x-ray imaging system comprises: at least one drive unit for changing a relative location of the sample mount and the x-ray source; and a feedback control device for performing a feedback control of the distance between the x-ray source and the sample based on a distance measurement of the sensor unit and by actuating the at least one drive unit.

Having the at least one drive unit means that a distance between the x-ray source and the sample can be adjusted.

Having the feedback control device means that a distance between the x-ray source and the sample can be controlled such that it is maintained in a closed control loop at a predetermined set distance. For example, a distance between the x-ray source and the sample can be maintained at a value corresponding to a desired x-ray flux density at the region of interest of the sample, and, hence, to a desired exposure time of the sample and desired throughput of the imaging system.

Further, by the closed control loop, undesired distance values can be avoided. For example, a physical contact of the x-ray target and the sample can be avoided.

The at least one drive unit includes, for example, a drive unit for displacing the sample mount in a direction towards the x-ray source and away from the x-ray source. In addition or instead, the at least one drive unit includes, for example, a further drive unit for displacing the x-ray source in a direction towards the sample mount and away from the sample mount.

The feedback control device is, for example, configured to: receive an actual value of a distance indicative for a distance between the x-ray source and the sample from a sensor unit; derive a further actual value of the distance between the x-ray source and the sample based on the received actual value; determine a deviation of the derived further actual value from a predetermined set value of the distance between the x-ray source and the sample; determine a control value based on the determined deviation; and generate a control signal for controlling the at least one drive unit based on the determined control value.

The respective unit described above and/or below, e.g., the control device, the feedback control device, the feedback control unit, and the deviation determining unit, can be implemented in hardware or in software. When implemented in hardware, the respective unit can be configured as device and/or as part of a device, e.g., a computer or a microprocessor. When implemented in software, the respective unit can be configured as computer program product, as routine, as algorithm, as part of a program code and/or as executable object.

In some embodiments, the x-ray imaging system comprises a sample mount for supporting the sample rotatably around a rotation axis, wherein the x-ray imaging system is configured for obtaining two-dimensional transmission images of the region of interest of the sample for different rotation angles of the sample with respect to the rotation axis, and for reconstructing a three-dimensional image of the region of interest based on the two-dimensional transmission images.

The x-ray imaging system comprises, for example, a control device for reconstructing the three-dimensional images.

For example, the x-ray imaging system is configured for obtaining two-dimensional transmission images of the region of interest of the sample for different rotation angles of the sample with respect to the rotation axis, wherein the rotation angles span a large angular range of, for example, 180° or more (e.g., 270° or more, 360°).

According to an aspect, the disclosure provides a method for operating an x-ray imaging system is provided. The method comprises: a) arranging a sample on a sample mount such that a region of interest of the sample is arranged at an opening of the sample mount; b) emitting x-rays towards the region of interest of the sample; c) detecting x-rays transmitted through the region of interest, wherein the emitted x-rays and/or the transmitted x-rays pass through the opening of the sample mount.

According to some embodiments of a method, the sample is arranged on the sample mount by use of a relocation unit independent from the sample mount.

Having the relocation unit means that the sample can be relatively easily arranged on the sample mount such that its region of interest is placed on the opening. Moreover, having the separate relocation unit for relocating the sample with respect to the sample mount means that the sample mount itself does not need to be relocatable apart from rotation around its rotation axis. This can help allow for an easier configuration, manufacture and maintenance of the sample mount.

According to some embodiments of a method, the method further comprises: detecting an actual distance between an x-ray source of the x-ray imaging system and the sample; and performing a feedback control of the distance between the x-ray source and the sample based on the detected actual distance and a predetermined set distance between the x-ray source and the sample.

The embodiments and features described with reference to the x-ray imaging system of the present disclosure apply mutatis mutandis to the method of the present disclosure.

Further possible implementations or alternative solutions of the disclosure also encompass combinations—that are not explicitly mentioned herein—of features described above or below with regard to the embodiments. The person skilled in the art may also add individual or isolated aspects and features to the most basic form of the disclosure.

### BRIEF DESCRIPTION OF THE DRAWINGS

Further embodiments, features and aspects of the present disclosure will become apparent from the subsequent description and dependent claims, taken in conjunction with the accompanying drawings, in which:

FIG. 1 shows a schematic view of an x-ray imaging system for imaging a sample;

FIG. 2 shows a schematic view of an x-ray imaging system for imaging a sample;

FIG. 3 shows a sample mount with a sample of the x-ray imaging system of FIG. 1, 2 or 6;

FIG. 4 shows a sample mount with a sample of the x-ray imaging system of FIG. 1, 2 or 6;

FIG. 5 shows a sample mount with a sample of the x-ray imaging system of FIG. 1, 2 or 6;

FIG. 6 shows a schematic view of an x-ray imaging system for imaging a sample;

FIG. 7 shows a control loop for a feedback control of a distance between an x-ray source and a sample of the x-ray imaging system of FIG. 1, 2 or 6; and

FIG. 8 shows a flow chart illustrating a method for operating an x-ray imaging system.

### DETAILED DESCRIPTION

In the Figures, like reference numerals designate like or functionally equivalent elements, unless otherwise indicated.

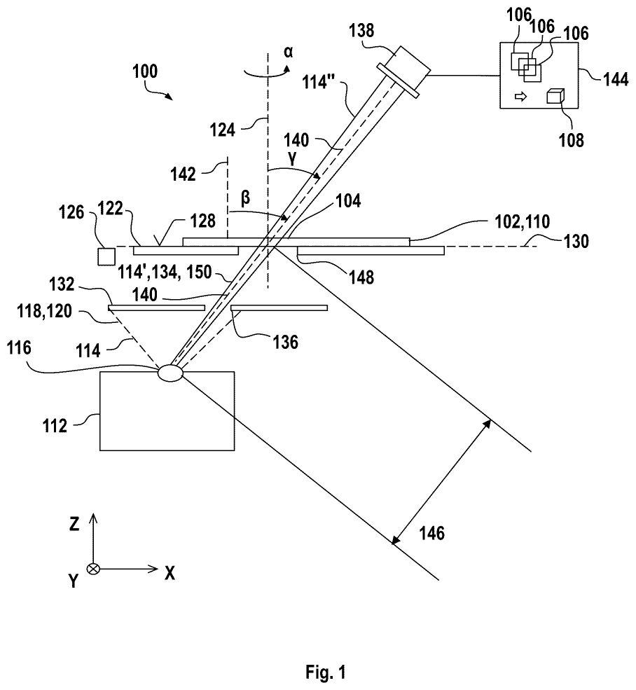

FIG. 1 shows a schematic view of an x-ray imaging system 100 according to an embodiment. The x-ray imaging system 100 is used for imaging a sample 102, for example a region of interest 104 of the sample 102. The x-ray imaging system 100 is configured to obtain two-dimensional transmission images 106 of the region of interest 104 for different rotation angles α of the sample 102. Based on the two-dimensional transmission images 106, a three-dimensional (3D) image 108 of the region of interest 104 is reconstructed to reveal interior structures of the region of interest 104. The x-ray imaging system 100 is, hence, an x-ray 3D imaging system obtaining 3D images 108 by x-ray laminography and/or x-ray tomography. The sample 102 is, for example, a flat object extended in a main plane (e.g., the xy-plane in FIG. 1). The sample 102 is, for example, a wafer 110 comprising electronic and/or semiconductor components. Just as an example, the x-ray imaging system 100 may be used to inspect the wafer 110 to investigate the quality of packaging of electronic components of the wafer 110. For example, the quality of mechanical and electrical bonding (e.g., buried interconnections) of the electronic components may be controlled.

The x-ray imaging system 100 comprises an x-ray source 112 for emitting x-rays 114. The x-rays 114 are emitted from a source region 116 of the x-ray source 112. The x-ray source 112 emits a diverging beam 118 of x-rays 114. In other words, the x-ray source 112 emits a cone 120 of x-rays 114. The sample 102 is arranged within the x-ray emission cone 120.

The x-ray imaging system 100 further comprises a sample mount 122 for supporting the sample 102 rotatably around a rotation axis 124. The rotation axis 124 passes, for example, through the region of interest 104 of the sample 102. For example, the rotation axis 124 can be arranged off-center with respect to a center of the sample 102. A rotation drive 126 for rotating the sample mount 122 and, hence, the sample 102, is shown schematically in FIG. 1. Furthermore, the sample mount 122 has a support surface 128 for supporting the sample 102, wherein the support surface 128 defines an object plane 130 of the x-ray imaging system 100.

The x-ray imaging system 100 may further optionally comprise, for example, a shield stop 132 arranged between the x-ray source 112 and the sample mount 122. The shield stop 132 is, for example, arranged in a light path of the x-rays 114 emitted from the x-ray source 112. The shield stop 132 serves to select a usable portion 134 (sub cone 134) of the x-ray cone 120. Moreover, the shield stop 132 protects uninspected regions of the sample 102 from x-ray exposure. The shield stop 132 has an aperture 136 through which the usable portion 134 of the x-ray light 114 (114′) propagates in the direction of the region of interest 104 of the sample 102 and transmits the region of interest 104 of the sample 102. The x-ray imaging system 100 further comprises a position-sensitive x-ray detector 138 for detecting x-rays 114″ transmitted through the region of interest 104 of the sample 102. The position-sensitive x-ray detector 138 is, for example, configured to convert the incoming x-rays 114″ into light of longer wavelength, e.g., UV-light, visible light or infrared light. The x-ray detector 138 includes, for example, a scintillator material at a transfer field of the detector 138 for converting the x-rays 114″ into detectable light and a detector array 138 (e.g., a CCD or CMOS array) for detecting the detectable light. FIG. 1 displays an x-ray propagation axis 140 of the x-ray imaging system 100. For example, a central axis of the portion 134 (sub light cone 134) of the x-ray light 114 passing through the shield stop 132 defines the x-ray propagation axis 140. The x-ray propagation axis 140 extends from the x-ray source 112 (i.e., the source region 116 of the x-ray source 112), through the region of interest 104 of the sample 102, and to the position-sensitive x-ray detector 138. As can be seen in FIG. 1, the x-ray propagation axis 140 of the x-ray imaging system 100 is, for example, inclined with respect to a surface normal 142 of the sample mount 122 by a first angle β. In addition, the x-ray propagation axis 140 is, for example, inclined with respect to the rotation axis 124 by a second angle γ. In the example of FIG. 1, the surface normal 142 of the sample mount 122 and the rotation axis 124 are arranged parallel to each other and, hence, the first angle β and the second angle γ have the same size.

The x-ray exposures 106 obtained at different rotation angles α of the sample 102 are reconstructed to a 3D image 108 by a control system 144 of the imaging system 100.

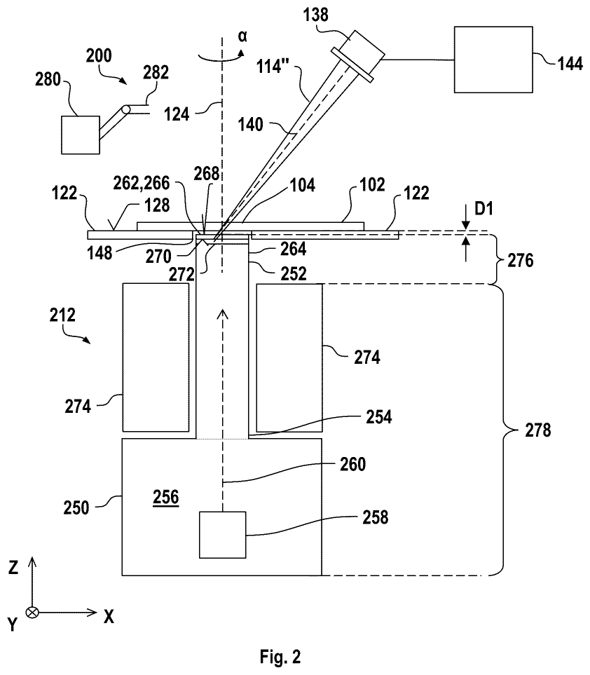

The x-ray imaging system 100 provides microscopic imaging. A magnification and, hence, a spatial resolution, of the x-ray imaging system 100 depends on the size of the source region 116 of the x-ray source 112. Moreover, an imaging time to obtain a 3D image 108 of the region of interest 104 of the sample 102 depends on the x-ray flux density at the region of interest 104. The imaging time (exposure time) limits, for example, a throughput rate when imaging multiple samples 102 with the x-ray imaging system 100. The smaller the distance 146 between the x-ray source 112 and the sample 102, the higher is the x-ray flux density at the region of interest 104 of the sample 102. For example, the x-ray flux incident on the region of interest 104 is inversely proportional to the square of the distance 146 of the region of interest 104 from the x-ray source 112 (for example, from an x-ray target of the x-ray source 112). As shown in FIG. 1, the sample mount 122 has an opening 148 for passing through of the x-rays 114′ emitted from the x-ray source 112 to the sample 102 (and/or for at least partially accommodating a protruding portion 276 of the x-ray source 112, 212, FIG. 2). With the opening 148 of the sample mount 122, it can be prevented that the x-ray beam 134 traveling from the x-ray source 112 to the region of interest 104 of the sample 102 and further to the x-ray detector 138 transmits the sample mount 122. In other words, a beam path 150 of the x-ray beam 134 emitted from the x-ray source 112, transmitted through the region of interest 104 and detected by the detector 138 is free of the sample mount 122. Hence, a distortion of the x-ray beam 134 by material of the sample mount 122 can be avoided.

In the examples shown in the figures, the x-ray imaging system 100 is configured such that the x-ray beam 134 emitted from the x-ray source 112 passes through the opening 148 of the sample mount 122 before irradiating the region of interest 104 of the sample 102. However, although not shown in the figures, an x-ray imaging system may also be configured such that—in the orientation of FIG. 1—an x-ray source 112 is arranged above the sample 102 and the sample mount 122 and an x-ray detector 138 is arranged below the sample 102 and the sample mount 122. In this case, the opening 148 of the sample mount 122 would be configured for passing through of the x-rays 114″ transmitted through the region of interest 104 and traveling through the detector 138. In other words, in this case, an x-ray beam already transmitted through the region of interest 104 of the sample 102 passes through the opening 148 of the sample mount 122 before reaching the detector 138.

FIG. 2 shows an x-ray imaging system 200 according to a further embodiment. The x-ray imaging system 200 of FIG. 2 differs from the x-ray imaging system 100 of FIG. 1 by omitting of the shield stop 132 and by a different configuration of an x-ray source 212. As shown in FIG. 2, the x-ray source 212 comprises a vacuum chamber 250. The x-ray source 212 further comprises a flight tube 252 fluidly connected at its proximal end 254 to the vacuum chamber 250. A vacuum atmosphere 256 is provided inside the vacuum chamber 250 and the flight tube 252.

The x-ray source 212 further incudes an electron source 258 accommodated in the vacuum chamber 250. The electron source 258 is configured for emitting an electron beam 260 towards the flight tube 252 such that the electron beam 260 flies through the flight tube 252.

The x-ray source 212 comprises in addition a carrier element 262 (e.g., made from diamond) arranged at a distal end 264 of the flight tube 252. The carrier element 262 is x-ray transmissive and forms a vacuum window 266 of the flight tube 252. The carrier element 262 comprises an outer surface 268 with respect to the flight tube 252 and an inner surface 270, arranged inside the vacuum atmosphere 256 of the flight tube 252. The carrier element 262 carries at its inner surface 270 an x-ray target 272 (e.g., made from tungsten).

The electron beam 260 traveling through the flight tube 252, hits the x-ray target 272 and causes the x-ray target 272 to generate x-rays 114 (FIG. 1). The generated x-rays 114 are emitted from the x-ray source 212 through the vacuum window 266.

The x-ray source 212 further comprises electron optics units 274 arranged around the flight tube 204 for deflecting, focusing and shaping the electron beam 260. The electron optics units 274 are shown only schematically in FIG. 2. The electron optics units 274 may include a magnetic focus lens as well as other electron optics.

As shown in FIG. 2, the x-ray source 212 comprises a protruding portion 276 protruding from a remaining portion 278 of the x-ray source 212. The protruding portion 276 includes the x-ray target 272 and the vacuum window 266.

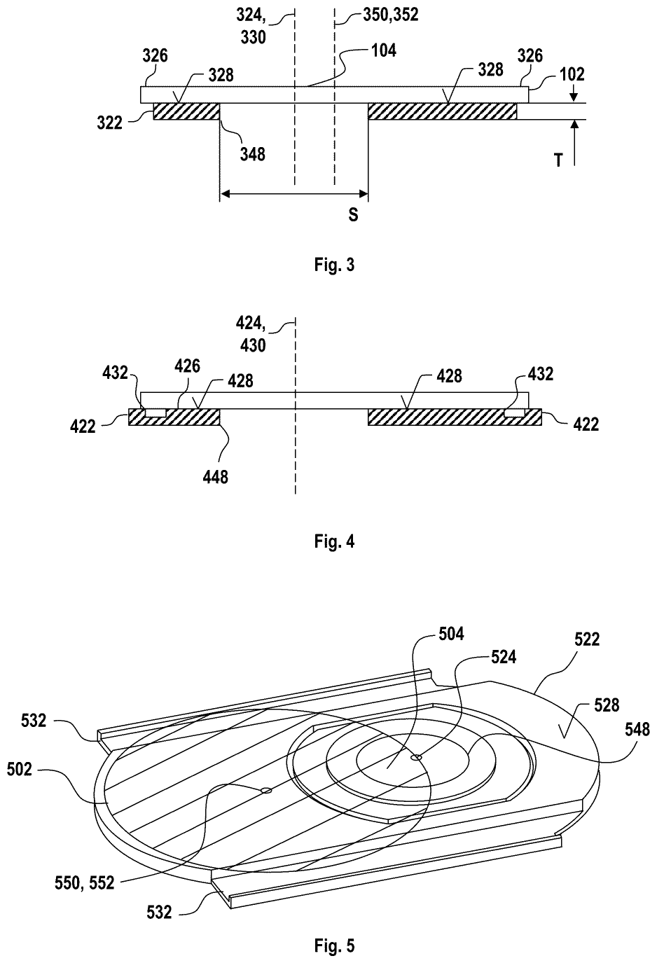

The protruding portion 276 of the x-ray source 212 is, for example, configured for at least partial insertion into the opening 148 of the sample mount 122. This allows to arrange the x-ray source 212, for example the x-ray target 272, very close to the sample 102. A distance D1 between the x-ray source 212 and the sample 102 is denoted with the reference sign D1 in FIG. 2. In the orientation of FIG. 2, the distance D1 is, for example, a distance between a top surface of the carrier element 262/vacuum window 266 carrying the x-ray target 272 and a bottom surface of the sample 102. The distance D1 is, for example, 1.0 mm or smaller, 0.8 mm or smaller, 0.6 mm or smaller, 0.5 mm or smaller, 0.4 mm or smaller, 0.3 mm or smaller, 0.2 mm or smaller, 0.1 mm or smaller and/or 0.05 mm or smaller. Thus, having the x-ray source 212 with the protruding portion 276 with the x-ray target 272 and having the sample mount 122 with the opening 148 allows to arrange the x-ray target 272 very close to the region of interest 104 of the sample 102. Thus, a high x-ray flux density can be provided at the region of interest 104 of the sample 102. Although not shown in FIG. 2, the x-ray source 212 may comprise a cooling arrangement for cooling the flight tube 252 including its distal end 264 for cooling, amongst others, the x-ray target 272 even though it is protruding from the remaining portion 278 of the x-ray source 212. Cooling of the x-ray target 272 is particularly important since a significant amount of heat is generated in the x-ray target 272 by the impacting electron beam 260. As illustrated in FIG. 2, the x-ray imaging system 200 may comprise a relocation unit 280 (e.g., a robotic unit) for relocating the sample 102 relative to the sample mount 122. With the relocation unit 280, the sample 102 can be easily arranged on the sample mount 122 such that the region of interest 104 of the sample 102 is arranged at the opening 148 of the sample mount 122. The relocation unit 280 is, for example, configured for translating (e.g., in x-, y-, z-direction) and/or rotating (e.g., in Rz direction) the sample 102 relative to the sample mount 122. FIG. 3 shows a sample mount 322 according to another embodiment. The sample mount 322 comprises a support surface 328 for supporting the sample 102 such that an outer portion 326 of the sample 102 is protruding from the support surface 328. Therefore, the outer protruding portion 326 of the sample 102—which is not laying on the support surface 328—can be mechanically contacted (e.g., taken up and/or lifted) by the relocation unit 280 (FIG. 2) to relocate the sample 102 with respect to the sample mount 122. In the example of FIG. 3, the outer portion 326 of the sample 102 is, for example, protruding not only from the support surface 328 but from the entire sample mount 322.

As illustrated in FIG. 3, a thickness T of any sample mount 122, 322, 422, 522 described herein has, for example, a value in the range of 1.5 mm to 4.0 mm (e.g., 2.5 mm). Furthermore, a size S (e.g., a diameter) of the opening 148, 348, 448, 548 of any sample mount 122, 322, 422, 522 described herein has, for example, a value in the range of 5 cm or larger, 10 cm or larger and/or 15 cm or larger.

As illustrated in FIG. 3, the relocation unit 280 (FIG. 2) is, for example, configured for rotating the sample 102 relative to any sample mount 122, 322, 422, 522 described herein around a further rotation axis 350. The further rotation axis 350 is arranged, for example, parallel to the rotation axis 124, 324, 424, 524 of the sample mount 122, 322, 422, 522. In addition, the further rotation axis 350 coincides, for example, with a central axis 352 of the sample 102.

FIG. 4 shows a sample mount 422 according to another embodiment. The sample mount 422 comprises a support side 426 including a support surface 428 for supporting the sample 102. Furthermore, the support side 426 comprises at least one recess 432 recessed from the support surface 428. In addition, the relocation unit 280 (FIG. 2) comprises at least one tool 282 for inserting the at least one tool 282 into the at least one recess 432 of the sample mount 122.

As visible in FIGS. 3 and 4, the rotation axis 124, 324, 424, 524 of any sample mount 122, 322, 422, 522 described herein passes through the opening 148, 348, 448, 548 of the sample mount 122, 322, 422, 522. The rotation axis 124, 324, 424, 524 of the sample mount 122, 322, 422, 522 coincides, for example, with a central axis 330, 430 of the opening 148, 348, 448, 548 of the sample mount 122, 322, 422, 522. Hence, when the region of interest 104 of the sample 102 is arranged at the opening 148, 348, 448, 548 of the sample mount 122, 322, 422, 522, a rotation of the sample 102 around the rotation axis 124, 324, 424, 524 allows imaging the region of interest 104 through the opening 148, 348, 448, 548 for different rotation angles α.

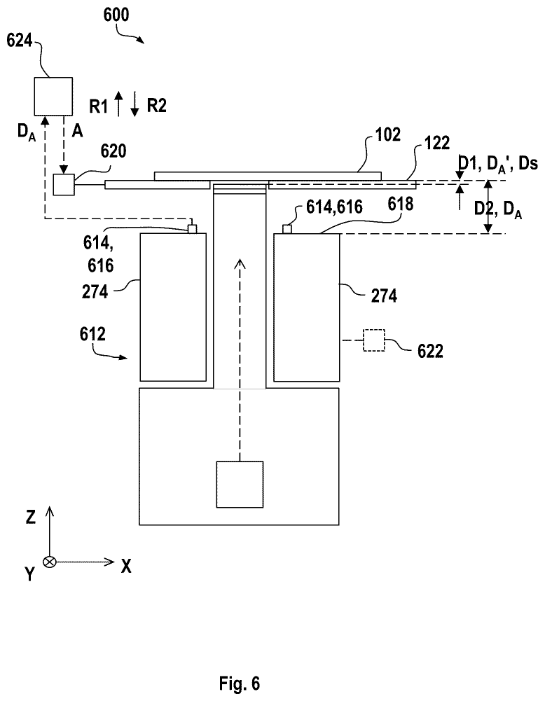

FIG. 5 shows a perspective view of a sample mount 522 according to another embodiment. The sample mount 522 comprises an opening 548 for passing of x-rays 114, 114′, 114″, the opening 548 being configured similar as the opening 148, 348, 448 of FIGS. 1 to 5. The sample mount 522 comprises a support surface 528 for supporting a sample 502. Furthermore, the sample mount 522 comprises recesses 532 configured as two grooves, the recesses 532 are recessed from the support surface 528. The sample 502 is arranged on the support surface 528 of the sample mount 522 via the relocation unit 280 (FIG. 2) such that its region of interest 504 is arranged on the opening 548 of the sample mount 522. FIG. 5 shows a state in which the sample 504 is arranged on the sample mount 522 such the region of interest 504 is partly arranged on the opening 548. By use of the relocation unit 280, the sample 504 can, for example, be translated in the direction R to arrange the region of interest 504 entirely on the opening 548. For example, by use of the relocation unit 280, the sample 504 can be translated in the direction R such that the region of interest 504 is intersected by the rotation axis 524 of the sample mount 522. In general, the relocation unit 280 is, for example, configured for translating the sample 504 in three translation degrees of freedom and for rotating the sample 504 with respect to a further rotation axis 550 which is coinciding with a central axis 552 of the sample 504. FIG. 6 shows an x-ray imaging system 600 according to another embodiment. The x-ray imaging system 600 differs from the x-ray imaging system 200 in FIG. 2 by a sensor unit 614, an actor unit 620, 622 and a feedback control device 624.

For example, the x-ray imaging system 600 may comprise a sensor unit 614 for monitoring the distance D1 between the x-ray source 612 and the sample 102. The sensor unit 614 comprises, for example, one or more distance sensors 616. The one or more distance sensors 616 are, for example, arranged at the x-ray source 612. The one or more distance sensors 616 are, for example, arranged at a ring-shaped outer wall 618 of the electron optics units 272 (e.g., of a magnetic focus lens). In this case, the sensor unit 614 is configured for measuring a distance D2 between the outer wall 618 and the sample 102 (e.g., the bottom surface of the sample 102). A control device 144 (FIG. 1) of the x-ray imaging system 600 may be configured for deriving the distance D1 from the measured distance D2.

The x-ray imaging system 600, e.g., a sample mount assembly, may comprise a drive unit 620 for displacing the sample mount 122 in a direction R1 towards the x-ray source 612 and a direction R2 away from the x-ray source 612. By using the drive unit 620, the distance D1 between the x-ray source 612 (e.g., the x-ray target 272) and the sample 102 can be set. The directions R, R1, and R2 are arranged parallel to a z-direction in the figures.

In addition or alternative to the drive unit 612 of the sample mount assembly, the x-ray imaging system 600, e.g., the x-ray source 612, may comprise a further drive unit 622 for displacing the x-ray source 612 in a direction R2 towards the sample mount 122 and a direction R1 away from the sample mount 122.

The x-ray imaging system 600 may include a feedback control device 624 for performing a feedback control of the distance D1 between the x-ray source 612 and the sample 102. With such a feedback control, the distance D1 between the x-ray source 612 and the sample 102 can be monitored and maintained at a desired distance D_{S}.

The feedback control device 624 is, for example, configured to receive an actual value D_{A} of a distance D2 indicative for a distance D1 between the x-ray source 612 and the sample 102 from the sensor unit 614. The feedback control device 624 is further configured to derive a further actual value DA′ of the distance D1 between the x-ray source 612 and the sample 102 based on the received actual value D_{A}. Moreover, the feedback control device 624 is configured to determine a deviation e(t) of the derived further actual value D_{A}′ from a predetermined set value D_{S} of the distance D1 between the x-ray source 612 and the sample 102. Then, the feedback control device 624 determines a control value u(t) based on the determined deviation e(t), and generates a control signal A for controlling a drive unit 620 of the sample mount 122 and/or of the x-ray source 612 based on the determined control value u(t).

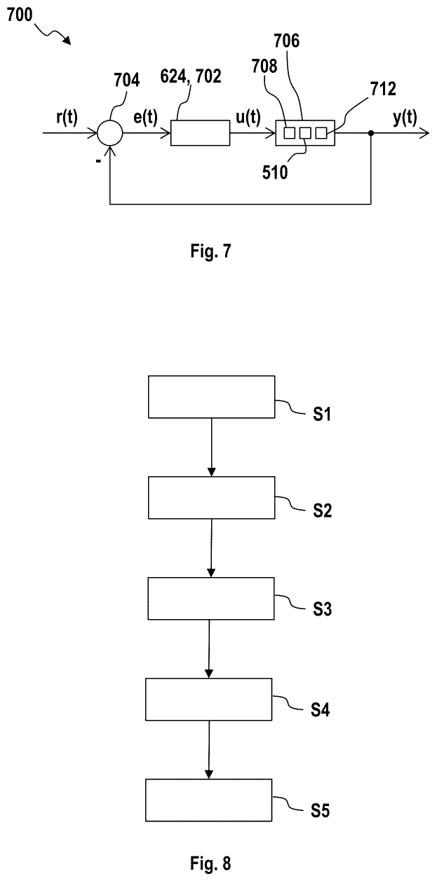

FIG. 7 shows a control loop 700 for performing a feedback control of the distance D1 between the x-ray source 612 and the sample 102. The control device 624 includes, for example, a control unit 702 for determining the control value u(t). The control device 624 includes further, for example, a deviation determining unit 704 for determining the deviation e(t).

The reference sign r(t) in FIG. 7 denotes a reference variable of the control loop 700. The reference variable r(t) corresponds to the set value D_{S} of the distance D1 between the x-ray source 612 and the sample 102. The reference variable r(t) may be a time-dependent parameter (time t) or may be a constant parameter. The reference sign y(t) denotes a (time-dependent) control variable of the control loop 700. The control variable y(t) corresponds to the further actual value D_{A}′ of the distance D1.

The deviation determining unit 704 is configured for determining the deviation e(t) of the control variable y(t) (i.e. the further actual value D_{A}′) from the reference variable r(t) (i.e. the set value D_{S}). Then, the feedback control unit 702 determines the control value u(t) based on the determined deviation e(t). For example, the feedback control unit 702 generates, based on the determined control value u(t), a control signal A (FIG. 6) for controlling the drive unit 620 of the sample mount assembly and/or for controlling the further drive unit 622 of the x-ray source 612.

The reference sign 706 in FIG. 7 denotes a control section of the control loop 700. The control section 706 includes a sensor unit 708 (sensor unit 614 in FIG. 6), for determining the actual value y(t) of the distance D1. The control section 706 includes an actuator unit 710 (e.g., the drive unit 620 and/or the further drive unit 622 in FIG. 6) for setting the distance D1. Furthermore, the reference sign 712 of the control section 706 of the control loop 700 indicates the system to be actuated, e.g., the x-ray source 612 and/or the sample mount assembly.

In the following, a method for operating an x-ray imaging system 100, 200, 600 (FIGS. 1, 2, 6) is described with reference to FIG. 8.

In a first step S1 of the method, a sample 102 is arranged on a sample mount 122 such that a region of interest 104 of the sample 102 is arranged at an opening 148 of the sample mount 122. The sample 102 is, for example, arranged on the sample mount 122 by use of a relocation unit 280 (FIG. 2).

In a second step S2 of the method, x-rays 114, 114′ are generated with an x-ray source 112 of the x-ray imaging system 100 such that the x-rays 114, 114′ transmit a region of interest 104 of a sample 102. In the example shown in the figures, the x-rays 114, 114′ emitted from the x-ray source 112 pass through the opening 148 of the sample mount 122 before transmitting through the region of interest 104 of the sample 102.

In a third step S3 of the method, x-rays 114″ transmitted through the region of interest 104 of the sample 102 are detected by an x-ray detector 138.

In an optional fourth step S4 of the method, an actual distance D1, D_{A}′ between the x-ray source 612 and the sample 102 is detected.

In an optional fifth step S5 of the method, a feedback control of the distance D1 between the x-ray source 612 and the sample 102 is performed based on the detected actual distance D_{A}′ and a predetermined set distance D_{S} between the x-ray source 612 and the sample 102.

Steps S4 and S5 may be carried out simultaneously with steps S1 to S3.

Although the present disclosure has been described in accordance with certain embodiments, it is obvious for the person skilled in the art that modifications are possible in all embodiments.

### REFERENCE NUMERALS

100 System
102 Sample
104 Region of interest
106 2D image
108 3D image
110 Wafer
112 Source
114 X-ray
114′, 114″ X-ray
116 Source region
118 Beam
120 Cone
122 Sample mount
124 Rotation axis
126 Rotation drive
128 Surface
130 Object plane
132 Shield stop
134 Sub cone
136 Aperture
138 Detector
140 Axis
142 Surface normal
144 Control system
146 Distance
148 Opening
200 System
252 Tube
254 End
256 Vacuum atmosphere
258 Source
260 Beam
262 Element
264 End
266 Window
268 Surface
270 Surface
272 Target
274 Unit
276 Portion
278 Portion
280 Unit
282 Tool
322 Sample mount
324 Axis
326 Portion
328 Surface
330 Axis
348 Opening
422 Sample mount
424 Axis
426 Support side
428 Surface
432 Recess
430 Axis
448 Opening
502 Sample
504 Region of interest
522 Sample mount
524 Axis
528 Surface
532 Recess
548 Opening
550 Axis
552 Axis
600 System
612 X-ray source
614 Sensor unit
616 Sensor
618 Wall
620 Drive unit
622 Drive unit
624 Control device
700 Control loop
702 Control unit
704 Determining unit
706 Control section
708 Sensor unit
712 Control section
α Angle
β Angle
γ Angle
A Signal
D_{A}, D_{A}′ Value
Ds Set value
D1, D2 Distance
e(t) Deviation
R, R1, R2 Direction
r(t) Reference variable
S Size
S1-S5 Step
T Thickness
u(t) Control Value
y(t) Control variable
x, y, z Direction

What is claimed is:

1. An x-ray imaging system, comprising:
a sample mount configured to mount a sample;
an x-ray source configured to emit x-rays toward a region of interest of the sample; and
an x-ray detector configured to detect x-rays transmitted through the region of interest of the sample,
wherein the sample mount comprises an opening configured so that, during use of the x-ray imaging system:
the emitted x-rays pass through opening; and or
the transmitted x-rays pass through the opening.

2. The x-ray imaging system of claim 1, wherein a beam path of an x-ray beam emitted from the x-ray source, transmitted through the region of interest, and detected by the detector is free of the sample mount.

3. The x-ray imaging system of claim 1, wherein a beam path of an x-ray beam emitted from the x-ray source, transmitted through the region of interest, and detected by the detector passes through the opening in the sample mount.

4. The x-ray imaging system of claim 1, wherein the beam path of the x-ray beam emitted from the x-ray source, transmitted through the region of interest, and detected by the detector does not contact the sample mount.

5. The x-ray imaging system of claim 1, wherein the x-ray imaging system is configured such that an x-ray beam emitted from the x-ray source passes through the opening in the sample mount before irradiating the region of interest of the sample.

6. The x-ray imaging system of claim 1, wherein:
the x-ray source comprises a first portion and second portion different from the first portion;
the first portion protrudes from the second portion;
the first comprises an x-ray target; and
the first portion at least partially disposed in the opening in the sample mount.

7. The x-ray imaging system of claim 1, wherein the sample mount is configured to rotate around a first rotation axis passing through the opening in the sample mount.

8. The x-ray imaging system of claim 7, wherein the first rotation axis coincides with a central axis of the opening in the sample mount.

9. The x-ray imaging system of claim 1, further comprising a unit configured to: i) relocate the sample relative to the sample mount; and ii) arrange the sample on the sample mount so that the region of interest of the sample is at the opening of the sample mount.

10. The x-ray imaging system of claim 9, wherein the unit is configured to:
translate and/or rotate the sample relative to the sample mount;
rotate the sample relative to the sample mount around a second rotation axis, and the second axis that: a) is parallel to the first rotation axis; and/or b) coincides with a central axis of the sample.

11. The x-ray imaging system of claim 9, wherein the sample mount comprises a support surface configured to support the sample so that an outer portion the sample protrudes from the support surface.

12. The x-ray imaging system of claim 9, wherein the sample mount comprises a support side which comprises a support surface configured to support the sample, the support side comprises a recess recessed from the support surface, and the relocation unit comprises a tool insertable into the recess of the sample mount.

13. The x-ray imaging system of claim 1, further comprising a sensor unit configured to detect a distance between the x-ray source and the sample.

14. The x-ray imaging system of claim 13, further comprising:
a drive unit configured to change a relative location of the sample mount and the x-ray source; and
a feedback control device configured to control of the distance between the x-ray source and the sample by actuating the drive unit based on a distance measurement of the sensor unit.

15. The x-ray imaging system of claim 1, wherein the x-ray source is a distance of at most one millimeter from the region of interest of the sample.

16. The x-ray imaging system of claim 1, wherein the opening in the sample mount comprises a cover, and the pin hole has a size or a diameter that is at least 1% larger than a size or a diameter of an x-ray beam directed toward the region of interest of the sample.

17. A method for operating an x-ray imaging system, the method comprising:
a) arranging a sample on a sample mount within the x-ray imaging system so that a region of interest of the sample is at an opening of the sample mount;
b) after a), emitting x-rays toward the region of interest of the sample; and
c) during and/or after b), detecting x-rays transmitted through the region of interest,
wherein the emitted x-rays and/or the transmitted x-rays pass through the opening in the sample mount.

18. The method of claim 17, comprising using a relocation unit to arrange the sample on the sample mount, wherein the relocation unit is independent from the sample mount.

19. The method of claim 18, further comprising:
detecting an actual distance between an x-ray source of the x-ray imaging system and the sample;
controlling the distance between the x-ray source and the sample based on the detected actual distance and a predetermined set distance between the x-ray source and the sample.

20. The method of claim 17, further comprising:
detecting an actual distance between an x-ray source of the x-ray imaging system and the sample;
controlling the distance between the x-ray source and the sample based on the detected actual distance and a predetermined set distance between the x-ray source and the sample.
